(19) United States
(12) Patent Application Publication
(10) Pub. No.: US 2010/0119325 A1
(43) Pub. Date: May 13, 2010

(54) STUD RETAINING FASTENER ASSEMBLY

(76) Inventor: David W. Edland, Chippewa Falls, WI (US)

Correspondence Address: ILLINOIS TOOL WORKS INC., 3600 WEST LAKE AVENUE, PATENT DEPARTMENT, GLENVIEW, IL, 60025, US

(21) Appl. No.: 12/612,237

(22) Filed: Nov. 4, 2009

Related U.S. Application Data
(60) Provisional application No. 61/112,240, filed on Nov. 7, 2008.

(51) Int. Cl. F16B 37/14

(52) U.S. Cl. 411/182

(57) ABSTRACT

A fastener assembly adapted to facilitate the secure placement of an overlay structure of rigid or flexible character in juxtaposed relation to a support panel by engagement with one or more studs projecting outwardly from the support panel. The fastener assembly includes a body portion with an axial through hole and with one or more rotatable legs. The leg members are adapted to rotate outwardly to a spread condition across a surface of the overlay structure facing away from the support panel. The fastener assembly further includes a pin member adapted for retention within the body portion. The pin member includes an axially oriented stud acceptance cavity adapted to receive a stud projecting outwardly from the support panel. One or more flexible stud retention arms are disposed radially at least partially about the stud acceptance cavity. Distal edges of the stud retention arms engage the surface of the stud and block withdrawal of the stud from the stud acceptance cavity.

### CROSS-REFERENCE TO RELATED APPLICATION

This Application claims the benefit of U.S. Provisional Application Ser. No. 61/112,240 filed Nov. 7, 2008, the contents of which are hereby incorporated by reference as if fully set forth herein.

### FIELD OF THE INVENTION

The present invention relates generally to a fastener assembly and is more particularly directed to a fastener assembly adapted to matedly engage and retain an elongated stud element projecting outwardly from a support surface and to concurrently grip a flexible or rigid structure in overlying relation to the support surface. The fastener assembly incorporates a hollow pin member held within a body member. The hollow pin member includes an internal cavity adapted to matedly engage and retain the stud element.

### BACKGROUND OF THE INVENTION

Transportation vehicles and other environments of use may require a covering panel to be retained in overlying relation to a panel surface. By way of example only, a motor vehicle typically incorporates a metal firewall at a position below the instrument panel. This firewall may be covered by an insulator pad or blanket of generally pliable material. It is desirable to establish and maintain a stable connection between the firewall and the covering insulator pad. It may also be desirable to be able to remove the insulator pad for purposes of servicing and/or replacement. The engagement and disengagement of the insulator pad or other covering panel is typically carried out in a so called “blind” condition due to the location of the firewall. Thus, the placement and removal is normally carried out primarily by feel without the benefit of substantial visibility.

### SUMMARY OF THE INVENTION

The present invention provides a fastener assembly adapted to facilitate the secure placement of an insulator pad or other overlay structure of rigid or flexible character in juxtaposed relation to a firewall or other support panel by engagement with one or more studs projecting outwardly from the support panel. The fastener assembly includes a hollow body portion with an axial through hole and with one or more rotatable legs adapted for insertion through the overlay structure. The leg members are adapted to rotate outwardly to a spread condition across a surface of the overlay structure facing away from the support panel. The fastener assembly further includes a pin member adapted for retention within the body portion. The pin member includes an axially oriented stud acceptance cavity adapted to receive a stud projecting outwardly from the support panel. One or more flexible stud retention arms are disposed radially at least partially about the stud acceptance cavity. Distal edges of the stud retention arms engage the surface of the stud and block withdrawal of the stud from the stud acceptance cavity.

### BRIEF DESCRIPTION OF THE DRAWINGS

FIG. 1 is an exploded perspective view of one exemplary embodiment of a fastener assembly in accordance with the present invention;

FIG. 2 is a cut-away side view of the body portion of the exemplary fastener assembly of FIG. 1 with the legs in the down position;

FIG. 3 is a cut-away side view of the pin portion of the exemplary fastener assembly of FIG. 1 with a threaded stud shown in phantom disposed within the stud acceptance cavity;

FIG. 4 is a view illustrating the exemplary fastener assembly of FIG. 1 in an intermediate assembly state with the body portion of the assembly extending through an overlay structure shown in section and with the legs in a down position;

FIG. 5 is a view similar to FIG. 4 with the exemplary fastener assembly in a fully assembled state with the legs in a spread and locked condition across an outer surface of the overlay structure; and

FIG. 6 illustrates the relative orientation of multiple fastener assemblies and multiple outwardly projecting studs for attachment of an overlay across a support panel structure.

Before the embodiments of the intention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENTS

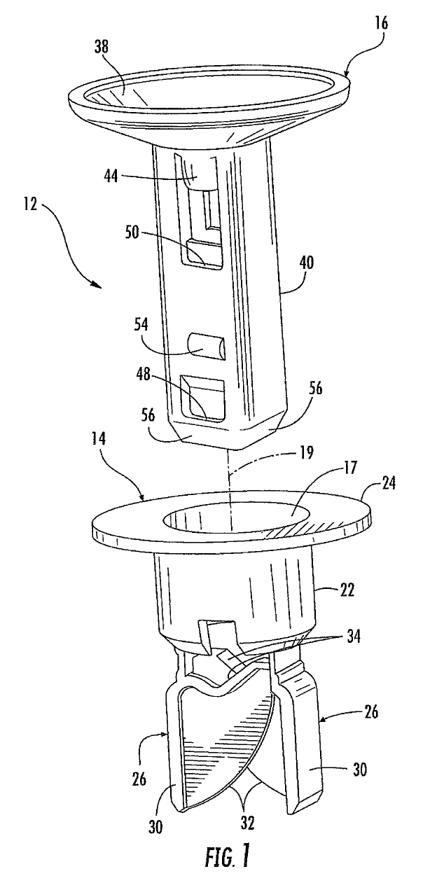

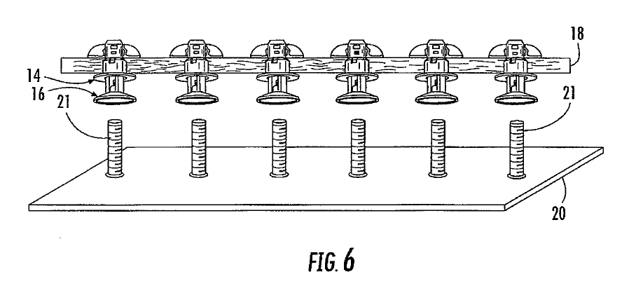

Reference will now be made to the drawings, wherein to the extent possible, like elements are designated by like reference numerals throughout the various views. Referring to FIG. 1, an exemplary fastener assembly 12 is shown. In the illustrated arrangement, the fastener assembly 12 includes a hollow body portion 14 and a pin member 16 configured for acceptance within a through hole 17 extending through the body portion 14 along a central axis 19. The fastener assembly 12 may be formed from molded plastic, metal, or other materials or combinations of materials as may be desired. As will be described further hereinafter, the fastener assembly 12 may be used to secure a juxtaposed arrangement between an overlay structure 18 of rigid or pliable character and a support panel 20 including one or more outwardly projecting studs 21 (FIG. 6).

Referring jointly to FIGS. 1-3, in the exemplary configuration, the body portion 14 includes a generally cylindrical base segment 22 defining a wall surrounding the through hole 17. The cylindrical base segment 22 extends downwardly away from an enhanced diameter collar 24 disposed circumferentially about the inlet opening for the trough hole 17. A pair of leg members 26 are disposed below the base segment 22 with an operative connection between the base segment 22 and the leg members 26 provided by living hinges 28. As shown, the living hinges are preferably in the form of relatively narrow bendable strips of material formed in integral relation with the base segment 22 and the corresponding leg members 26. Thus, the exemplary body portion 14 including the base segment 22, the enhanced diameter collar 24, the leg members 26 and the connective living hinges 28 may be molded as a single piece if desired.

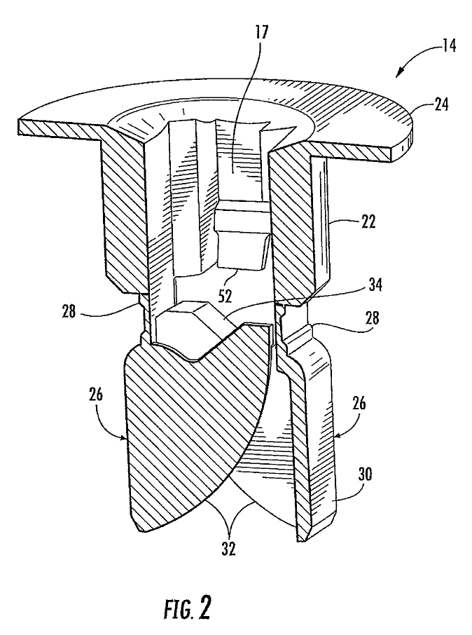

As illustrated, in the exemplary construction the leg members 26 include outboard edge flaps 30 defining substantially planar outer surfaces facing generally outwardly away from the central axis 19 when the legs are in the down position as shown in FIGS. 1 and 2. The thickness of the edge flaps 30 is slightly greater than the thickness of the adjacent living hinges 28. The leg members 26 in the exemplary construction also include inboard wing segments 32 disposed in planes transverse to the edge flaps 30. The planes of the wing segments 32 are substantially parallel and are arranged on opposite sides of the central axis 19 relative to one another.

In the exemplary construction, the wing segments 32 include sloped upper edges 34 adapted to engage and slide along the lower surface of the pin member 16 upon passage of the lower portion of the pin member 16 through the outlet of the through hole 17. The sloped upper edges 34 thus act as camming surfaces when acted upon by the pin member 16 thereby causing the leg members 26 to rotate outwardly in a manner as illustrated in FIG. 5.

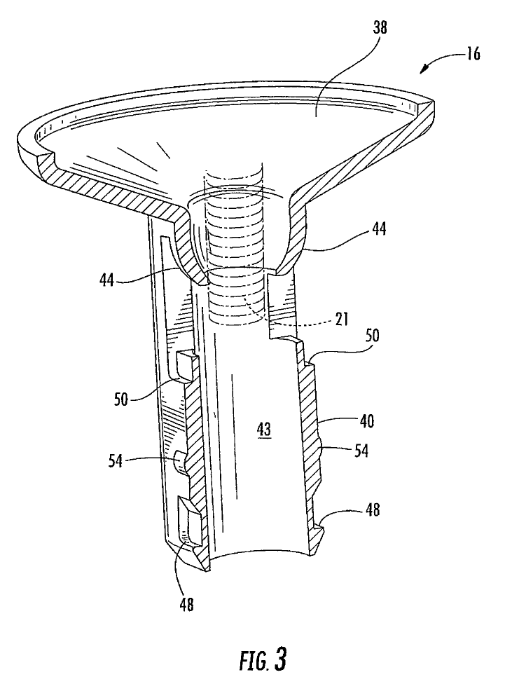

As best seen in FIGS. 1 and 3, in the exemplary configuration the pin member 16 includes an enhanced diameter concave stud guide 38 having a generally dish-shaped configuration defining an entrance for a stud 21. As will be appreciated, the broad, concave configuration of the stud guide 38 facilitates blind insertion of the stud 21 by guiding the stud 21 into substantial alignment with the central axis 19. An elongated finger element 40 of polygonal cross-section extends downwardly away from the stud guide 38. The finger element 40 is hollow at least partially along its length to define a stud acceptance channel 43 for receipt of a stud 21 entering from the stud guide along the central axis 19.

As illustrated, the stud guide 38 opens into the stud acceptance channel 43. Stud retention arms 44 are disposed radially at least partially about the exit of the stud guide 38 to define a transition between the stud guide 38 and the stud acceptance channel 43. The stud retention arms 44 are preferably flexible and are angled or curved inwardly such that their distal edges project towards the central axis 19 to define an expansible throat passage transitioning between the stud guide 38 and the stud acceptance channel 43. The distal edges of the stud retention arms 44 are normally spaced a distance from one another which is slightly smaller than the outer diameter of the stud 21. Thus, upon insertion of the stud 21, the distal edges of the stud retention elements press inwardly against the surface of the stud 21. Such a configuration permits relatively easy insertion of the stud 21 with concurrent outward flexing of the stud retention elements. However, outward withdrawal is blocked by the stud retention arms 44. While two stud retention arms 44 are illustrated, a greater or lesser number may likewise be used.

In the illustrated exemplary arrangement, the stud retention arms 44 are disposed on opposing sides of the central axis 19 and have an inward curvature in the longitudinal direction to define a longitudinally concave face that faces the central axis 19. The stud retention arms terminate at inwardly projecting distal edges. The distal edges are curved circumferentially so as to engage the surface of a curved surface stud 21 in a generally complementary cradling relation when the stud is inserted as shown in FIG. 3. Of course, other constructions which provide engagement between a portion of the stud retention arms 44 and the surface of the stud 21 may likewise be used if desired.

In the exemplary configuration, the pin member 16 includes a first pair of opposing shelf structures 48 disposed adjacent to the distal end of the finger element 40. The pin member 16 also includes a second pair of opposing shelf structures 50 disposed above the first pair and in substantially aligned relation with the first pair. As seen in FIG. 2, the body portion 14 includes one or more latch members 52 (only one shown) in the form of flexible tabs disposed at the walls of the through hole 17. In the exemplary construction, the latch members are angled downwardly and inwardly towards the central axis 19. The latch members 52 snap behind the lower ledges of the shelf structures 48, 50 when the pin member 16 is inserted into the body portion. Following insertion, the latch members block against retraction of the pin member 16.

The inclusion of a first pair of opposing shelf structures 48 at a relatively low position along the finger element 40 and a second pair of opposing shelf structures 50 at a higher position enables the pin member 16 to be held against retraction in either a partially or a completely inserted state. Accordingly, the pin member 16 may be inserted to a first stage partially into the body portion and held in place by engagement between the latch members 52 and the first pair of opposing shelf structures 48. Upon complete insertion to a second stage, the pin member 16 may be held in place by engagement between the latch members 52 and the second pair of opposing shelf structures 50. By way of example only, and not limitation, the partially inserted state may be used for shipment while the fully assembled state may be used in operation to secure the overlay structure 18 in place in the manner as will be described further hereinafter. In the illustrated and potentially preferred configuration, outwardly projecting surface bumps 54 may be disposed between the first pair of opposing shelf structures 48 and the second pair of opposing shelf structures 50. Such surface bumps may be used to control the required force for insertion of the finger element 40 into the body portion 14 from the partially assembled state to the fully assembled state.

As best seen in FIG. 2, in the exemplary configuration the through hole 17 has an interior polygonal cross-sectional shape for receipt of the finger element 40 along the central axis 19. This polygonal shape preferably substantially blocks relative rotation between the pin member 16 and the body portion 14 once the finger element 40 is inserted. In this regard, the interior cross-section of the through hole may be substantially complementary to the exterior shape of the finger element 40 although other geometries that prevent relative rotation also may be used.

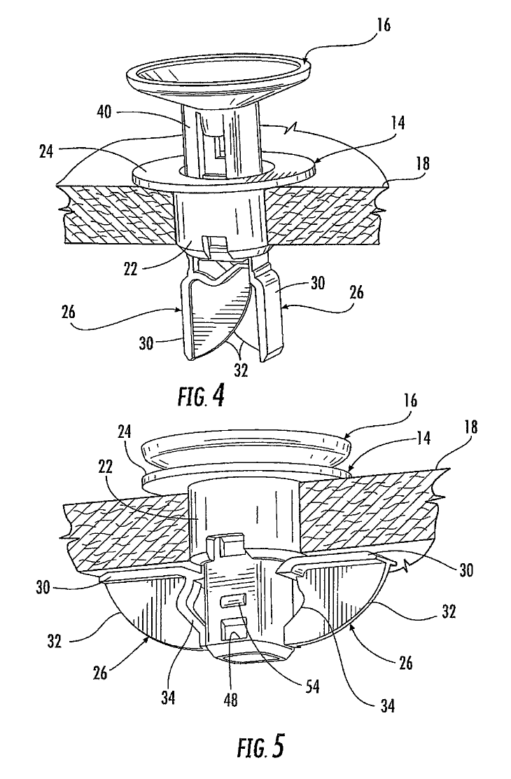

Referring jointly to FIGS. 1 and 4-6, the operation of the fastener assembly 12 in adjoining an overlay structure 18 to a support panel 20 with outwardly projecting studs will now be described. In an intermediate assembly state shown in FIG. 4, the pin member 16 has been inserted partially into the body portion 14. In this partial insertion condition, the latch members 52 (FIG. 2) engage the first pair of opposing self structures 48 at the interior of the base segment 22. The pin member 16 is thus restrained against falling out of the body portion 14 and the fastener assembly 12 can be shipped or otherwise manipulated as a unitary structure. By way of example only, in this partial insertion condition, the body portion 14 may be inserted across a portion of the overlay structure 18 such that the enhanced diameter collar 24 rests on a surface of the overlay structure. Of course, the body portion 14 also may be inserted across the overlay structure 18 without the pin member 16 in place if desired. The pin member 16 is then inserted to clamp the overlay structure in place as will now be described.

As seen in FIGS. 1 and 5, in the exemplary configuration the distal end of the finger element 40 has chamfered, inwardly angled lower edges 56 defining a parallelepiped configuration. The lower edges 56 cooperatively engage and slide along the sloped upper edges 34 of the wing segments 32 when the finger element 40 is pressed into the through hole 17 a sufficient distance such that the lower edges pass beyond the base segment 22. This cam action causes the leg members 26 to rotate outwardly and upwardly about the living hinges 28 such that the outboard edge flaps 30 are disposed in adjacent opposing relation to the surface of the overlay structure 18 as shown in FIG. 5. In this condition the pin member 16 has been fully inserted and is held in place against outward movement by engagement between the latch members 52 (FIG. 2) and the second pair of opposing shelf structures 50. In this condition, the leg members 26 are locked in the spread orientation and are blocked against returning to the position of FIG. 4. Moreover, as indicated previously, the body portion 14 cannot be rotated relative to the pin member 16 due to the cooperating polygonal geometries of the through hole 17 and the finger element 40. Thus, any rotation of the body portion 14 is translated to the pin member 16.

According to one potentially desirable operating practice, the overlay structure 18 may be held in clamped relation by the assembled fastener assembly in the manner as illustrated in FIG. 5. Referring to FIGS. 3 and 6, a stud 21 may be press fit through the stud guide 38 and into the stud acceptance channel 43 at the interior of the finger element 40. As noted previously, the stud guide 38 incorporates an enhanced diameter concave configuration. As will be appreciated, such a configuration aids in making a so called “blind” connection in which the user is unable to see the stud by guiding the stud into substantial alignment with the central axis 19. With the stud 21 pressed in place, the distal edges of the stud retention arms 44 press inwardly and engage the surface threads of the stud 21. In this arrangement the stud retention arms 44 block against outward retraction of the stud 21. The overlay structure 18 is thus held in covering relation to the support panel 20.

As noted previously, the body portion 14 and the pin member 16 are restricted from rotating relative to one another. Thus, rotation of the body portion 14 is translated to the pin member 16. This cooperative rotation aids in removing the fastener assembly 12 from a stud 21 for purposes of repair or replacement following the original installation if required. Specifically, with the leg members 26 in the raised condition as shown in FIGS. 5 and 6, the wing segments 32 take on the configuration of a wing nut. Thus, a user can apply a leveraged torque to rotate the body portion 14. This rotation is translated to the pin member 16 such that the fastener assembly rotates as a unitary structure about the central axis 19. Since the distal edges of the stud retention arms 44 engage the threads or other surface contours of the stud 21, and the stud 21 remains stationary, the applied rotation causes the distal edges of the stud retention arms 44 to track along the threads such that the fastener assembly can be backed off of the stud 21 until full disengagement has been achieved. The fastener assembly 12 may subsequently reengage the stud 21 by the press-fit insertion as described previously. Thus, the stud 21 may be readily engaged and disengaged as desired.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Various features of the invention are set forth in the following claims.

What is claimed is:

1. A fastener assembly adapted to hold an overlay structure in opposing relation to a support surface, the support surface having an elongated stud projecting outwardly from the support surface, the fastener assembly comprising:
a pin member including an elongated finger portion having a proximal end and a distal end, a stud acceptance cavity disposed at the interior of the finger portion, the stud acceptance cavity adapted to receive the elongated stud along a stud acceptance axis, the pin member further including a stud guide disposed above the proximal end of the finger portion, the stud guide having an axially disposed outlet projecting into the stud acceptance cavity along the stud acceptance axis, at least one flexible stud retention arm disposed in at least partial surrounding relation to the outlet of the stud guide, the stud retention arm including a distal edge projecting inwardly towards the stud acceptance axis, the distal edge positioned to engage a surface of the elongated stud held within the stud acceptance cavity to block outward withdrawal of the elongated stud from the stud acceptance cavity; and
a body portion including a base and at least one rotatable leg member operatively connected to the base, wherein the base includes a through hole passageway extending axially through the base, the through hole passageway adapted to receive the finger portion of the pin member, the base including at least one latch member adapted to engage the finger portion upon insertion of the finger portion into the through hole passageway and to block retraction of the finger portion from the through hole passageway, said at least one rotatable leg member normally extending downwardly away from the base and including an upper edge adapted to engage a lower surface of the pin member upon insertion of the lower surface of the pin member through the through hole passageway such that said at least one rotatable leg member rotates outwardly towards a surface of the overlay structure facing away from the support surface.

2. A fastener assembly as recited in claim 1, wherein the stud guide includes a substantially dish-shaped concave surface facing away from the finger portion.

3. A fastener assembly as recited in claim 1, wherein the stud retention arm is inwardly curved defining a longitudinally concave surface facing towards the stud acceptance axis.

4. A fastener assembly as recited in claim 3, wherein the distal edge of the stud retention arm has a circumferentially concave curvature.

5. A fastener assembly as recited in claim 4, wherein the distal edge of the stud retention arm has a circumferentially concave curvature substantially complementary to an outer surface of the elongated stud.

6. A fastener assembly as recited in claim 1, wherein the elongated finger portion has a polygonal outer diameter geometry and the through hole passageway has a polygonal inner diameter geometry such that the elongated finger portion is held in substantially non-rotatable relation within the through hole passageway.

7. A fastener assembly as recited in claim 1, wherein the finger portion includes a first shelf structure disposed at a first position along the finger portion and at least a second shelf structure disposed at a second position along the finger portion above the first position, the first shelf structure adapted to engage said at least one latch member at a first stage of insertion of the finger portion along the through hole passageway and the second shelf structure adapted to engage said at least one latch member at a second subsequent stage of insertion of the finger portion along the through hole passageway such that that at each of the first stage and the second stage the finger portion is blocked against retraction from the through hole passageway.

8. A fastener assembly as recited in claim 7, wherein the first shelf structure and the second shelf structure are disposed in substantial alignment with one another along the finger portion.

9. A fastener assembly as recited in claim 1, wherein a living hinge extends between the base and said at least one rotatable leg member.

10. A fastener assembly adapted to hold an overlay structure in opposing relation to a support surface, the support surface having an elongated stud projecting outwardly from the support surface, the fastener assembly comprising:
a pin member including an elongated finger portion having a proximal end and a distal end, a stud acceptance cavity disposed at the interior of the finger portion, the stud acceptance cavity adapted to receive the elongated stud along a stud acceptance axis, the pin member further including a stud guide of enhanced diameter relative to the finger portion disposed above the proximal end of the finger portion, the stud guide including a substantially dish-shaped concave surface facing away from the finger portion, the stud guide having an axially disposed outlet projecting into the stud acceptance cavity along the stud acceptance axis, a plurality of flexible stud retention arms disposed in at least partial surrounding relation to the outlet of the stud guide, the stud retention arms each including a distal edge projecting inwardly towards the stud acceptance axis, the distal edge positioned to engage a surface of the elongated stud held within the stud acceptance cavity to block outward withdrawal of the elongated stud from the stud acceptance cavity; and
a body portion including a hollow base having a substantially cylindrical outer surface, a collar having a diameter greater than the base disposed above the base, and a pair of rotatable leg members extending downwardly from the base, wherein the base includes a through hole passageway extending axially through the base, the through hole passageway adapted to receive the finger portion of the pin member, the base including a plurality of latch members adapted to engage the finger portion upon insertion of the finger portion into the through hole passageway and to block retraction of the finger portion from the through hole passageway, the rotatable leg members including an upper edge adapted to engage a lower surface of the pin member upon insertion of the lower surface of the pin member through the through hole passageway such that the rotatable leg members rotate outwardly away from one another towards a surface of the overlay structure facing away from the support surface.

11. A fastener assembly as recited in claim 10, wherein one or more of the stud retention arms is inwardly curved defining a longitudinally concave surface facing towards the stud acceptance axis.

12. A fastener assembly as recited in claim 11, wherein the distal edge of one or more of the stud retention arms has a circumferentially concave curvature.

13. A fastener assembly as recited in claim 12, wherein the distal edge of one or more of the stud retention arms has a circumferentially concave curvature substantially complementary to an outer surface of the elongated stud.

14. A fastener assembly as recited in claim 10, wherein the elongated finger portion has a polygonal outer diameter geometry and the through hole passageway has a polygonal inner diameter geometry such that the elongated finger portion is held in substantially non-rotatable relation within the through hole passageway.

15. A fastener assembly as recited in claim 1, wherein the finger portion includes a first pair of opposing shelf structures disposed at a first height position along the finger portion and at least a second pair of opposing shelf structures disposed at a second height position along the finger portion above the first height position, the first pair of opposing shelf structures adapted to engage the plurality of latch members at a first stage of insertion of the finger portion along the through hole passageway and the second pair of opposing shelf structure adapted to engage the plurality of latch members at a second subsequent stage of insertion of the finger portion along the through hole passageway such that that at each of the first stage and the second stage the finger portion is blocked against retraction from the through hole passageway.

16. A fastener assembly as recited in claim 15, wherein the first pair of opposing shelf structures and the second pair of opposing shelf structures are disposed in substantial alignment with one another along the finger portion.

17. A fastener assembly as recited in claim 10, wherein living hinges extend between the base and the rotatable leg members.

18. A fastener assembly adapted to hold an overlay structure in opposing relation to a support surface, the support surface having an elongated stud projecting outwardly from the support surface, the fastener assembly comprising:
a pin member including an elongated finger portion having a proximal end and a distal end, a stud acceptance cavity disposed at the interior of the finger portion, the stud acceptance cavity adapted to receive the elongated stud along a stud acceptance axis, the pin member further including a stud guide of enhanced diameter relative to the finger portion disposed above the proximal end of the finger portion, the stud guide including a substantially dish-shaped concave surface facing away from the finger portion, the stud guide having an axially disposed outlet projecting into the stud acceptance cavity along the stud acceptance axis, a pair of flexible stud retention arms disposed in opposing relation to one another to define an expansible throat at the outlet of the stud guide, the stud retention arms each including a distal edge projecting inwardly towards the stud acceptance axis, the distal edge positioned to engage a surface of the elongated stud held within the stud acceptance cavity to block outward withdrawal of the elongated stud from the stud acceptance cavity, wherein the stud retention arms are inwardly curved defining a longitudinally concave surface facing towards the stud acceptance axis; and
a body portion including a hollow base having a substantially cylindrical outer surface, a collar having a diameter greater than the base disposed above the base, and a pair of rotatable leg members extending downwardly from the base, wherein the base includes a through hole passageway extending axially through the base, the through hole passageway adapted to receive the finger portion of the pin member, the base including a plurality of latch members, one or more of the latch members comprising an inwardly and downwardly angled flexible tab adapted to engage the finger portion upon insertion of the finger portion into the through hole passageway and to block retraction of the finger portion from the through hole passageway, the rotatable leg members each including an upper edge adapted to engage a lower surface of the pin member upon insertion of the lower surface of the pin member through the through hole passageway such that the rotatable leg members rotate outwardly away from one another towards a surface of the overlay structure facing away from the support surface, wherein the finger portion includes a first pair of opposing shelf structures disposed at a first height position along the finger portion and at least a second pair of opposing shelf structures disposed at a second height position along the finger portion above the first height position, the first pair of opposing shelf structures adapted to engage the plurality of latch members at a first stage of insertion of the finger portion along the through hole passageway and the second pair of opposing shelf structure adapted to engage the plurality of latch members at a second subsequent stage of insertion of the finger portion along the through hole passageway such that that at each of the first stage and the second stage the finger portion is blocked against retraction from the through hole passageway, the first pair of opposing shelf structures and the second pair of opposing shelf structures are disposed in substantial alignment with one another along the finger portion.

19. A fastener assembly as recited in claim 18, wherein the distal edge of one or more of the stud retention arms has a circumferentially concave curvature substantially complementary to an outer surface of the elongated stud.

20. A fastener assembly as recited in claim 18, wherein the elongated finger portion has a polygonal outer diameter geometry and the through hole passageway has a polygonal inner diameter geometry such that the elongated finger portion is held in substantially non-rotatable relation within the through hole passageway.
